(19) United States
(12) Patent Application Publication
(10) Pub. No.: US 2025/0080620 A1
(43) Pub. Date: Mar. 6, 2025

(54) SYSTEM AND METHOD FOR COMMUNICATING WITH NEARBY USERS IN AN APPLICATION PROGRAM

(71) Applicant: Whos this GmbH, Davie, FL (US)

(72) Inventors: Nico Constantin Schubert, Davie, FL (US); Marc Engels, Davie, FL (US)

(21) Appl. No.: 18/602,305

(22) Filed: Mar. 12, 2024

Related U.S. Application Data
(60) Provisional application No. 63/446,881, filed on Feb. 19, 2023.

(51) Int. Cl. H04L 67/52; H04L 67/306

(52) U.S. Cl. CPC H04L 67/52; H04L 67/306

(57) ABSTRACT

A system for communicating with nearby users in an application program, including at least one user computing device in operable connection with a user network. An application server is in operable communication with the user network to host an application system for providing a communication platform to permit a first user to communicate with a second user wherein the first user and second user are within a user-defined radius. A location module is in communication with the application program to determine a location of a first user and at least a second user and to permit the communication between the first user and second user if each user is within a user-defined radius. A tracking module is in communication with the application program to permit the real-time location sharing of the first user to the second user. A user module permits each user to input one or more user preferences.

### CROSS-REFERENCE TO RELATED APPLICATIONS

The present application claims priority to U.S. Provisional Application No. 63/446,881 filed Feb. 19, 2023, titled “SYSTEM AND METHOD FOR COMMUNICATING WITH NEARBY USERS IN AN APPLICATION PROGRAM,” which is hereby incorporated by reference in its entirety.

### TECHNICAL FIELD

The embodiments generally relate to systems and methods for providing an application program for communicating with nearby users.

### BACKGROUND

Advances in network connectivity have allowed for humans to connect with one another remotely. Historically, humans have been limited to interacting with others via face-to-face interactions. More recently, wireless communication technologies, including the Internet have allowed people to communicate around the world. Although useful, it remains difficult to communicate with those nearby without a first introduction while still remaining selectively private under certain conditions.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments herein relate to a system and method for communicating with nearby users in an application program are disclosed. The system includes at least one user computing device in operable connection with a user network. An application server is in operable communication with the user network to host an application system for providing a communication platform to permit a first user to communicate with a second user wherein the first user and second user are within a user-defined radius and wherein such communication may be in the form of conveying, through a profile, accessing, viewing, and otherwise dynamically interacting with user profile information. A location module is in communication with the application program to determine a location of a first user and at least a second user and to permit the communication between the first user and second user if each user is within a user-defined radius. A tracking module is in communication with the application program to permit the real-time location sharing of the first user to the second user. A user module permits each user to input one or more user preferences.

The embodiments allow users to be interacted with once each user is within a user-defined radius (e.g., 100 meters). This interaction allows users to meet with others, view user information associated with other users, and otherwise interact with the various functionalities of the system.

The system provides an application program which gives user the peace-of-mind of being virtually monitored by other users of the application program as they are traveling. The first user can select one or more other users whom they wish to share their location, providing the other users the ability to monitor their location while they travel anywhere in the world. This may be useful while they travel locally, or internationally, etc.

While the system allows for the first user's location to be shared with other users of their choosing, the system also provides selective privacy via the “ghost mode” feature. This feature allows the user to stop sharing their location to other users, while making them undiscoverable to users in their area who would normally be able to see their location without the “ghost mode” feature.

The system also provides the advantage of enabling the user to identify one or more locations which are designated at their “home zone”. This feature provides the advantage of providing a location in which the user's location cannot be seen by others. Once the user enters one of their ‘home zone” locations, their location is private, allowing them to remain undisturbed.

In one aspect, each user may selectively enable a “ghost mode” feature which hides the user's location from other users until the feature is disabled. This enhances the selective privacy of the user experience.

In one aspect, each user may selectively enable a “home zone” feature which hides the user's location from other users while the user is located withing a user-defined radius (e.g., 100 meters) around a user-defined location. This enhances the selective privacy of the user experience, especially in relation to frequently visited locations or a personal or private nature.

In one aspect, the user module permits users to accrue points which can be reimbursed for various benefits or perks. The points are transmitted to the user for various actions performed within the application program.

In one aspect, a “take me home” interface is provided to allow the second user to track, in real-time, the location of the first user while traveling between the first location and the second location.

In one aspect, a communication module may transmit an alert to the second user once the first user has reached their home destination.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 shows a block diagram of a computer system, according to some embodiments;

FIG. 2 shows a block diagram of a computer system and an application program, according to some embodiments;

FIG. 3 illustrates a block diagram of the application program and databases, according to some embodiments;

FIG. 4 illustrates a screenshot of the user profile interface, according to some embodiments;

FIG. 5 illustrates a screenshot of the radar interface, according to some embodiments;

FIG. 6 illustrates a screenshot of the home zone interface, according to some embodiments;

FIG. 7 illustrates a screenshot of the ghost mode interface, according to some embodiments;

FIG. 8 illustrates a screenshot of the take me home interface, according to some embodiments;

FIG. 9 illustrates a flowchart for a method for communicating with nearby users in the application program, according to some embodiments;

FIG. 10 illustrates a flowchart for a method for monitoring the location of one or more users using the application program, according to some embodiments; and

FIG. 11 illustrates a flowchart for a method for hiding a user's location within the application program, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before various example embodiments are described in detail, it is noted that the embodiments reside primarily in combinations of components and procedures related to systems. Accordingly, system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be systems, methods, and/or computer program products at any possible technical detail level of integration. A computer program product can include, among other things, a computer-readable storage medium having computer-readable program instructions thereon for causing a processor to carry out aspects of the present disclosure.

In general, the embodiments provided herein relate to systems and methods for providing an application program which allows users to connect with one another who are in a predefined area. Users can search for other nearby users using a “radar” interface which illustrates a map and displays user profile icons within a user-defined radius (e.g., within 100 meters). If other users are found within the user-defined radius, they may interact with the user profile of one another to request to communicate or connect. The application program provides location monitoring of users if desired. For example, a “take me home” feature allows a second user to monitor and track a first users location. In a practical example, the first user is travelling home and wants to share their location in real-time with the second user. In such, the second user can monitor their progress towards the first user's destination. Once the first user reaches their destination (e.g., home), the second user receives a notification to alert them that the first user has reached their destination.

In some embodiments, the system allows users to input one or more locations representing an intended destination to and/or from which designated other users can track their location. This can be input using the “take me home” interface. The take me home interface allows the user to select the one or more locations which are their destination. This may be the user's home where they live, or it may be defined as another location to which they are travelling (e.g., a place of business, friends or families house, etc.).

In some embodiments, the application program provides a “ghost mode” function, wherein the user is able to hide their location and not be discovered by other users in their area. In such, the user may not be able to be found by other users and may not be able to find other users themselves. As a result, the ghost mode function provides selectable privacy settings to the user who may not always desire to be found by other users at a given time.

In some embodiments, the systems and methods provide user-selectable privacy settings, wherein the user can selectively input designations for by whom they may be seen, which users can interact with them and at what times, and which users can track their location in real-time.

In some embodiments, the application program provides a “home zone” function, wherein the user is able to input one or more “home” locations such that when the system detects that the user is located within a user-defined radius (e.g., 100 meters) around the user-defined location, the system automatically conceals the user's location and prevents the user from being discovered by other users in their area until the system determines the user is no longer located within the designated geographic area. In such, the user may not be able to be found by other users and may not be able to find other users themselves while located within the designated geographic area. This can be input using the “home zone” interface. The home zone interface allows the user to select the one or more locations wherein the user desires to have added privacy. This may be their home where they live, or it may be defined as another location the user frequents (e.g., a place of business, friends or families house, etc.).

In some embodiments, a user module allows the user to generate a user account and profile, link other third-party profiles (e.g., social media profiles), accrue points gained by using the system, set user preferences, and the like.

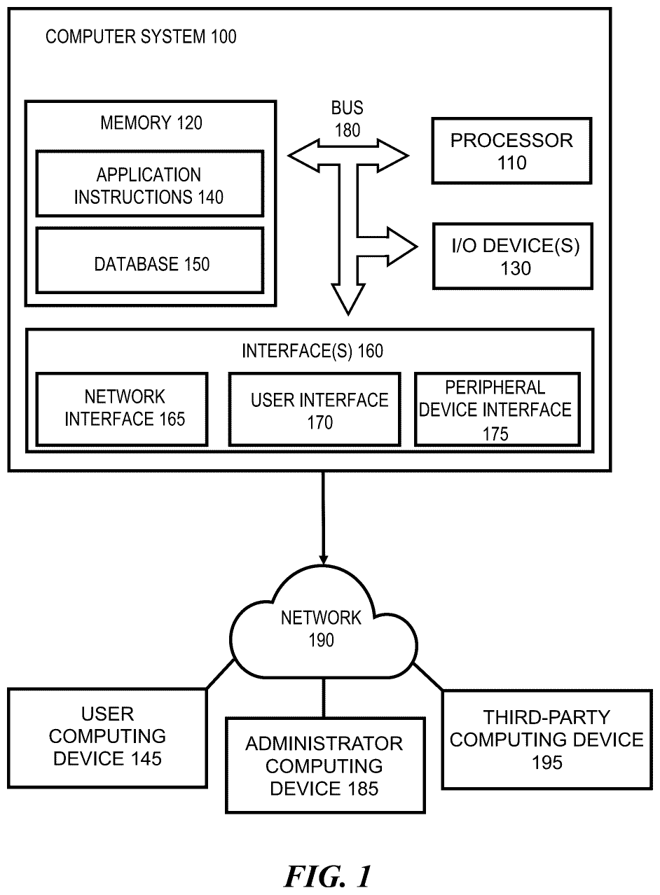

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computer system 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 140, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized a user (e.g., a healthcare provider) to interact with the various functionalities of the system including to perform patient rounds, handoff patient rounding responsibility, perform biometric verification tasks, and other associated tasks and functionalities of the system. The administrator computing device 185 is utilized by an administrative user to moderate content and to perform other administrative functions. The third-party computing device 195 may be utilized by third parties to receive communications from the user computing device 145, transmit communications to the user via the network, and otherwise interact with the various functionalities of the system.

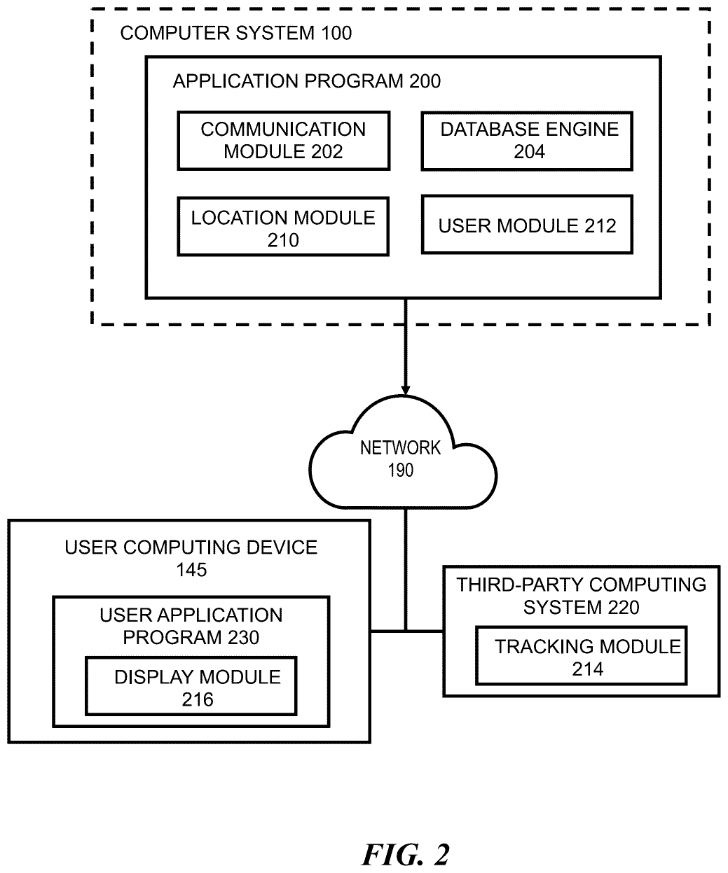

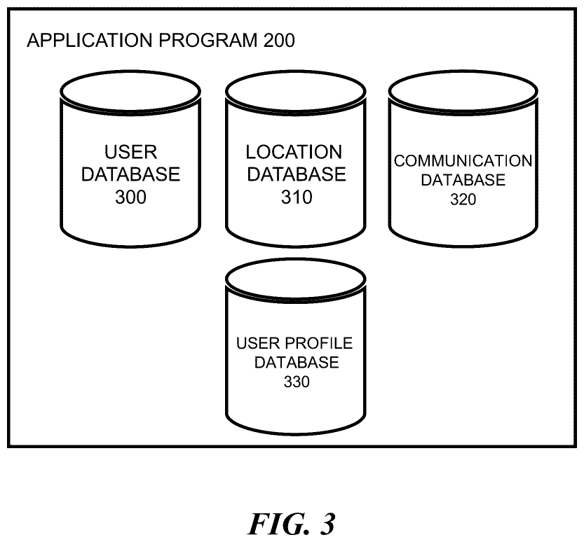

FIGS. 2 and 3 illustrate an example computer architecture for the application program 200 operated via the computer system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computer system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a location module 210, and a user module 212. The computer system 100 is further in operable communication via network 190 with a tracking module 214 contained within a third-party computing system 220, and a display module 216 contained within a user application program 230 located on the user computing device 145.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communication module 202 is configured to maintain one or more communication sessions with one or more servers, the administrator computing device 185, and/or one or more third-party computing device(s) 195.

In some embodiments, the communication module 202 allows two or more users to interact with one another, especially those within the user-determine radius determined by the location module.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the location module 210 is in operable communication with the user computing device 145 and application program. The location module 210 determines the users' locations and displays a map of the user's current location. The map is displayed on the radar interface which also shows other users who enable their discovery. The location module 210 may also determine if users are within a user-defined radius. If users are within the user-defined radius, there is provided a means for connecting the users with one another.

In some embodiments, the user module 212 facilitates the creation of a user account for the application system. The user module 212 may allow the user to create a user profile which includes user information, third-party profiles, points the user has accrued, and the like. In some embodiments, the user module 212 may allow the user to select a “ghost mode” functionality, wherein the user's location is not displayed to other users within the user-defined radius. This provides and maintains selectable privacy for the user while using the application program.

In some embodiments, the tracking module 214 is in operable communication with the application program 200 and user computing device 145 via network 190 to permit the user to indicate if they would like to be monitored by a second (or additional) user via location module 210 while traveling to a user-designated destination. In such, the first user is tracked by the second user between a first location and a second location. Alerts may be sent, via the communication module 202, once the first user has reached the second location.

In some embodiments, the display module 216 is in operable communication with the application program 200 and is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

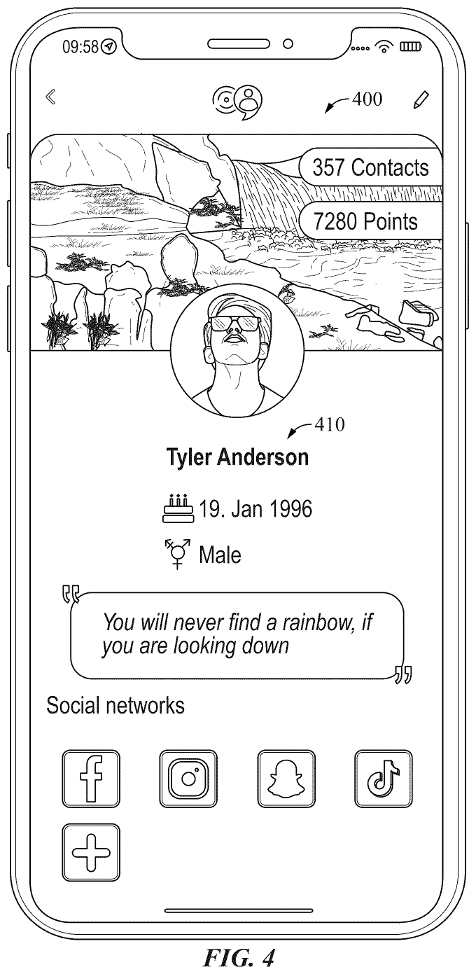

FIG. 3 illustrates a block diagram of the application program 200 and databases including a user database 300, a location database 310, a communication database 320, and a user profile database 330. The user database 300 stores user information, user input parameters (e.g., the radius within which they are discoverable), and user points they have accrued, and other user-associated parameters and information. The location database 310 stores home locations input by the user, a discoverable radius, etc. Other location-associated data may also be stored. The communication database 320 stores communications between each user, as well as other user-to-user data. The user profile database 330 stores user profile information input by the user via a user profile interface 400 (FIG. 4) to be associated with and/or displayed on a user profile 410 (FIG. 4).

FIG. 4 illustrates a screenshot of the user profile interface 400. The user profile interface displays the user profile 410 which includes user photos, user-associated information, location information, third-party system (e.g., social media profile) information (e.g., hyperlinks to the profile), and the like. The user profile interface 400 may also display points which the user has accrued over time. Points may be accrued in various ways, including by interacting with the system functionalities, interacting with other users, by purchasing points, etc. The points may be exchanged for credits (e.g., coins, etc.), to grant access to other functionalities of the system, profile extensions, benefits, perks, etc.

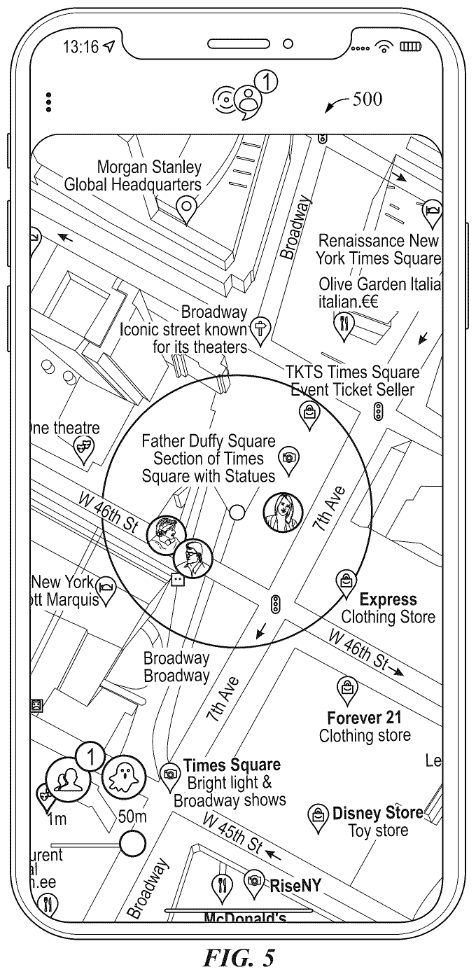

FIG. 5 illustrates a screenshot of the radar interface 500. The radar interface 500 displays other users within a user-defined radius with which the user may connect with. The radar interface 500 is provided via the location module to display a map of the user's surrounding area, as well as to display user icons representative of the location of other users.

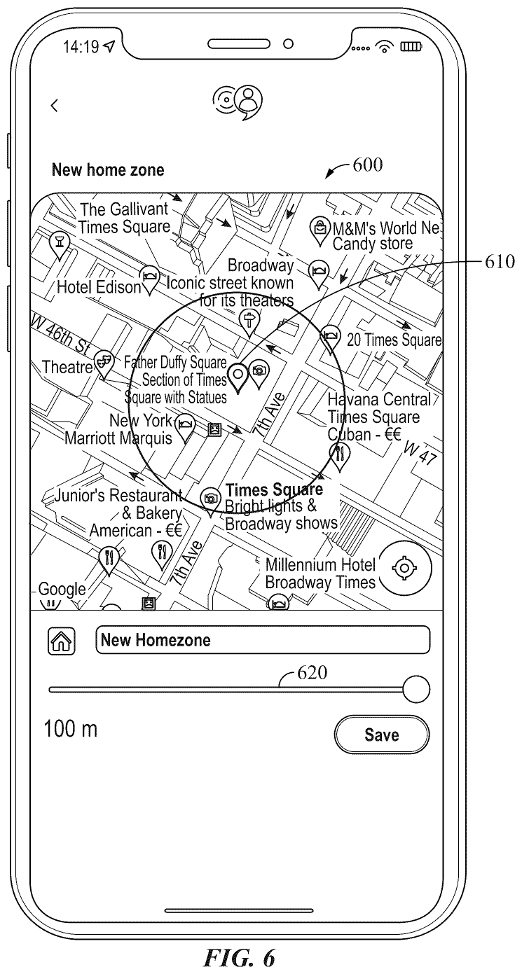

FIG. 6 illustrates a screenshot of the home zone interface 600 wherein the user may establish one or more home zones by selecting one or more locations 610 associated with a destination wherein the user desires to have added privacy, and a user-defined radius 620 (e.g., 100 meters) around the location 610 (a “home zone”). The location 610 may be defined as any location where the user may travel or frequent, such as their home, a friend or family member's home, a place of business, or any other location defined by the user. Upon the application program 200 determining, via the location module 210, that the user computing device 145 is located within the home zone, the user will no longer be displayed on the radar interface and cannot be seen or otherwise interacted with by other users until such time as the user computing device 145 is no longer located within the home zone. In some embodiments, users who the first user has already connected with may be still viewed and interacted with when located within a home zone. In some embodiments, the user may not be able to find or interact with other users themselves while located inside a home zone.

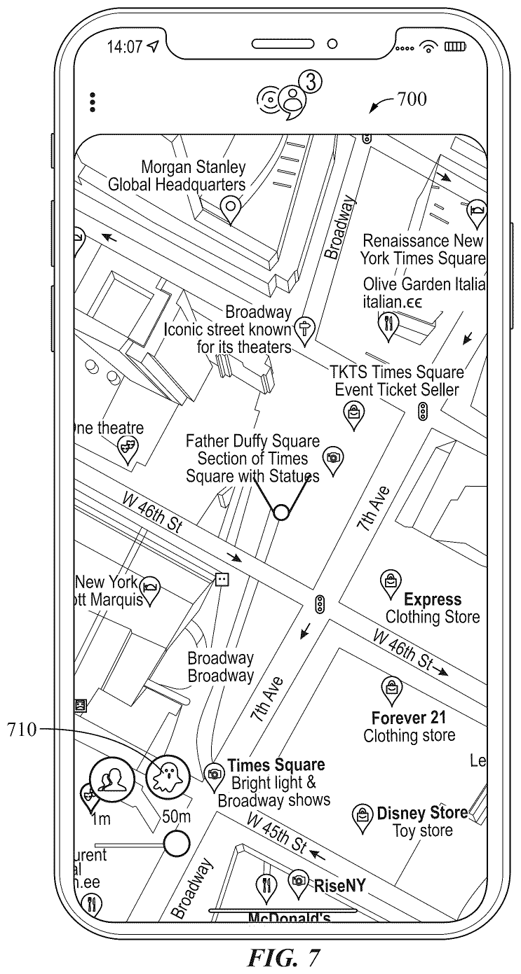

FIG. 7 illustrates a screenshot of the ghost mode interface 700 wherein the user may select, via button 710, to enter into the “ghost mode”. The ghost mode is defined as a setting wherein the user is not displayed on the radar interface and cannot be seen or otherwise interacted with by other users until ghost mode has been disabled by the user. In some embodiments, users who the first user has already connected with may be still viewed and interacted with when in ghost mode. In some embodiments, the user may not be able to find or interact with other users themselves while ghost mode is enabled.

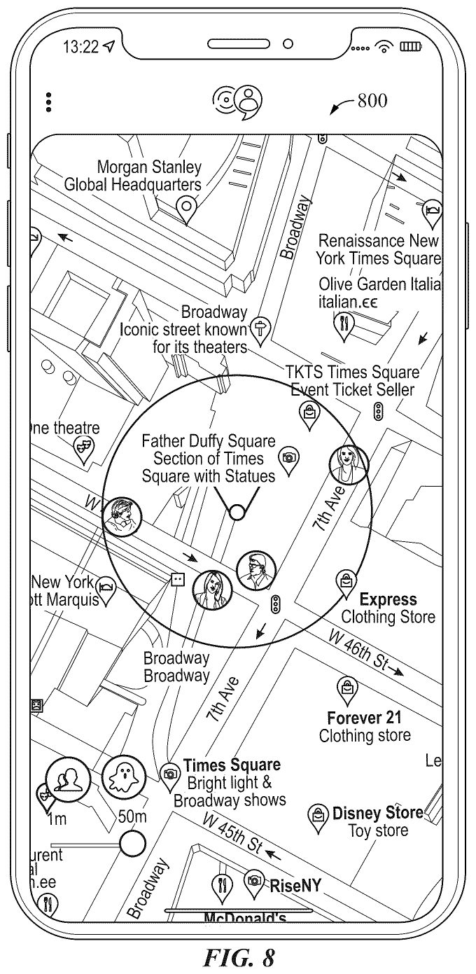

FIG. 8 illustrates a screenshot of a take me home interface 800 wherein the user may select one or more locations associated with a destination. The destination may be defined as any location to which the user is travelling, such as their home, a friend or family member's home, a place of business, or any other location defined as the users next destination. Upon a user entering a destination and granting a third-party user authorization or monitor its location via tracking module 214, the third-party user may, through the take me home interface 800 on a third-party computing device 195, monitor the user's progress towards the user-designated destination. Upon the user reaching its destination, the take me home interface 800 may transmit and display an alert to notify the third-party user.

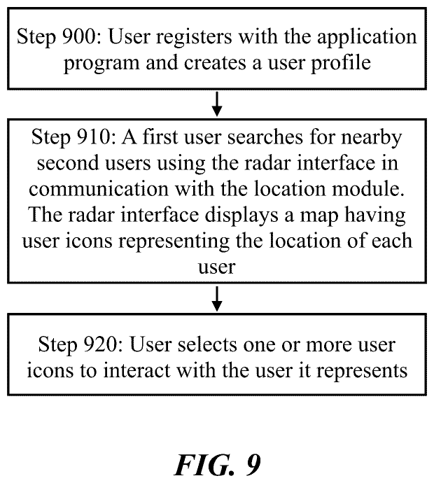

FIG. 9 illustrates a flowchart for a method for communicating with nearby users in an application program. In step 900, the user registers with the application program and creates a user profile. The user may input a plurality of user settings, preferences, and personal information, which is stored, by the user module, in the user profile database. In step 910, a first user may search for nearby second users using a radar interface in operable communication with the location module. The radar interface displays a map having a plurality of user icons thereon, each representing another user. In step 920, the user selects one or more user icons to interact with each user represented by each user icon.

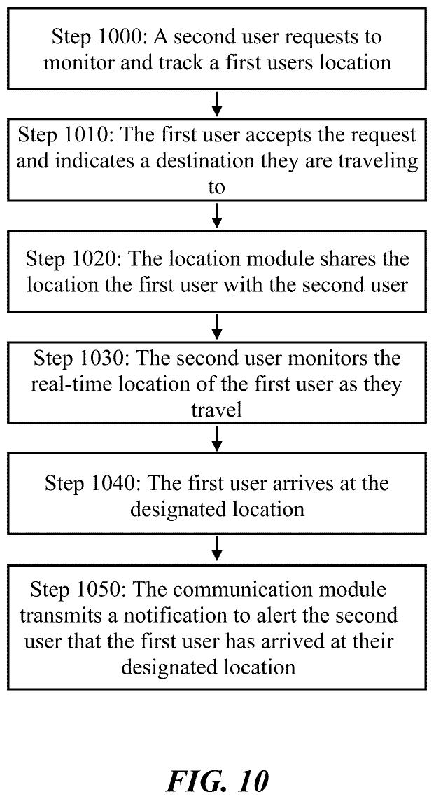

FIG. 10 illustrates a flowchart for a method for monitoring the location of one or more users using the application program. In step 1000, a second user requests to monitor and track a first users' location. In step 1010, the first user accepts the request and indicates a destination they are travelling to. In step 1020, the location module shares the location of the first user with the second user. In step 1030, the second user may view and monitor the real-time location of the first user. In step 1040, the first user arrives at a designated destination (e.g., their designated “home” location). In step 1050, the second user receives a notification, generated and transmitted by the communication module, to alert them that the first user has reached their designated destination.

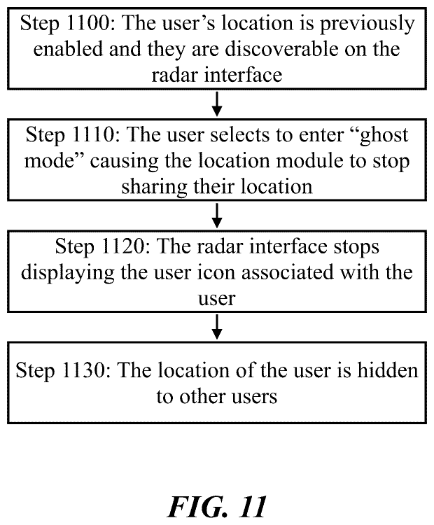

FIG. 11 illustrates a flowchart for a method for hiding a user's location within the application program, also referred to as the “ghost mode” function of the system. In step 1100, the user's location has been previously enabled and they are discoverable on the radar interface of the application program. In step 1110, the user selects to enter “ghost mode”, causing the location module to stop sharing the location of the user. In step 1120, the radar interface stops displaying the user icon associated with the user. In step 1130, as a function of the “ghost mode” the location user will not only be hidden to other users, they will also be unable to monitor the location of other users.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for communicating with nearby users in an application program, the system comprising:
at least one user computing device in operable connection with a user network;
an application server in operable communication with the user network, the application server configured to host an application system for providing a communication platform to permit a first user to communicate with a second user, wherein the first user and second user are within a user-defined radius, the application system having a user interface module for providing access to the application system through the user computing device;
a location module in communication with the application program, the location module to determine a location of a first user and at least a second user, and to permit the communication between the first user and second user if each user is within a user-defined radius; and
a tracking module in communication with the application program, the tracking module to permit the real-time location sharing of the first user to the second user;
a user module to permit each user to input one or more user preferences, the one or more user preferences including at least one privacy setting and the user-defined radius.

2. The system of claim 1, wherein the at least one privacy settings permits the user to disable their location.

3. The system of claim 1, wherein the at least one privacy setting includes user-associated information comprising at least one of the following: a plurality of personal information, one or more images, and one or more social media profiles.

4. The system of claim 1, wherein the user module stores, via a user database, a plurality of points accrued by the user.

5. The system of claim 1, further comprising a radar interface to display map.

6. The system of claim 5, wherein the map includes a plurality of user icons associated with one or more users within the user-defined radius.

7. The system of claim 1, wherein the user module stores at least one user-designated location associated with the first user.

8. The system of claim 7, wherein the tracking module permits the tracking of the first user, by the second user, between a first location and the at least one user-designated location.

9. The system of claim 8, further comprising a communication module to transmit an alert to the second user upon the first user arriving at the at least one home location.

10. The system of claim 2, wherein the enablement of the privacy setting permits the first user to disable their location until the privacy setting is disabled by the first user.

11. The system of claim 2, wherein the user module stores at least one user-designated location associated with the first user.

12. The system of claim 11, wherein the first user can designate a radius around the user-designated location such that the privacy setting disables the first user's location while the first user is within the radius.

13. A system for communicating with nearby users in an application program, the system comprising:
at least one user computing device in operable connection with a user network;
an application server in operable communication with the user network, the application server configured to host an application system for providing a communication platform to permit a first user to communicate with a second user, wherein the first user and second user are within a user-defined radius, the application system having a user interface module for providing access to the application system through the user computing device;
a location module in communication with the application program, the location module to determine a location of a first user and at least a second user, and to permit the communication between the first user and second user if each user is within a user-defined radius, wherein the first user designates a radius around the user-designated location such that a privacy setting disables the first user's location while the first user is within the radius;
a radar interface to display a plurality of user icons on a map, the plurality of user icons each associated with a user, wherein each of the plurality of icons represents the location of each user;
a tracking module in communication with the application program, the tracking module to permit the real-time location sharing of the first user to the second user, wherein the tracking module permits the tracking of the first user, by the second user, between a first location and the at least one user-designated location;
a communication module to transmit an alert to the second user upon the first user arriving at a destination.
a user module to permit each user to input one or more user preferences, the one or more user preferences including at least one privacy setting and the user-defined radius.

14. The system of claim 13, wherein the at least one privacy settings permits the user to disable their location.

15. The system of claim 13, wherein the at least one privacy setting includes user-associated information comprising at least one of the following: a plurality of personal information, one or more images, and one or more social media profiles.

16. The system of claim 13, wherein the user module stores, via a user database, a plurality of points accrued by the user.

17. The system of claim 13, wherein the user module stores at least one user-designated location associated with the first user.

18. The system of claim 13, wherein the enablement of the privacy setting permits the first user to disable their location until the privacy setting is disabled by the first user.

19. The system of claim 13, wherein the user module stores at least one user-designated location associated with the first user.

20. A computer program product comprising a non-transitory computer-usable medium having computer-readable program code embodied therein, wherein the computer-readable program code, when executed by a computing system, causes the computing system to implement a method comprising the steps of:
determining, via a location module, a location of a first user and at least a second user;
permitting the sharing of locations between the first user and the second user if each user is within a user-defined radius using a tracking module;
inputting, via a user module operated by the first user and the second user, one or more user preferences to establish one or more privacy settings and to establish the user defined radius.
